(19) United States
(12) Patent Application Publication
(10) Pub. No.: US 2026/0072988 A1
(43) Pub. Date: Mar. 12, 2026

(54) Interactive Chat Interface with Dynamic Elements Responsive to User Interaction

(71) Applicant: Oracle International Corporation, Redwood Shores, CA (US)

(72) Inventors: Jennifer Darmour, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/929,089

(22) Filed: Oct. 28, 2024

Related U.S. Application Data
(60) Provisional application No. 63/691,473, filed on Sep. 6, 2024.

(51) Int. Cl. G06F 16/9032

(52) U.S. Cl. CPC G06F 16/90332

(57) ABSTRACT

Techniques for presenting a dynamic chat interface include executing a query to identify a plurality of links, respectively associated with set of information, for responding to the query. The system displays the plurality of links in a first display order concurrently with the query in a chat interface of an application. Upon receiving a selection of a first link of the plurality of links, the system displays a first set of information associated with the first link in an information pane. Upon receiving a request to redisplay the plurality of links, based on the selection of the first link, the system modifies the first display order to generate a second display order for the plurality of links and displays the plurality of links in the second display order concurrently with the query in the chat interface.

### BENEFIT CLAIMS; RELATED APPLICATIONS; INCORPORATION BY REFERENCE

This application claims the benefit of U.S. Provisional Patent Application 63/691,473, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to an interactive chat interface for an application. In particular, the present disclosure relates to an intelligent chatbot that reviews messages, presents options for action based on the messages in the chat interface, and dynamically updates the options in response to user interaction.

### BACKGROUND

Some applications provide an interactive chat interface that allows a user to request information and instruct the application to perform actions. The user may need to navigate through information that was previously provided to find information that the user has not yet consumed. The user may need to use specific terminology to instruct the application to perform the actions.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for presenting links dynamically in a chat interface in accordance with one or more embodiments;

FIGS. 3A-B illustrate an example set of operations for presenting candidate actions dynamically in a chat interface in accordance with one or more embodiments;

FIGS. 4A-C illustrate an example of an interactive chat interface in accordance with one or more embodiments;

FIGS. 5A-B illustrate another example of an interactive chat interface in accordance with one or more embodiments;

FIG. 6 illustrates an example of a machine learning process in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. INTERACTIVE CHAT INTERFACE ARCHITECTURE
3. DYNAMICALLY UPDATING A CHAT INTERFACE
4. EXAMPLE EMBODIMENTS
5. MACHINE LEARNING
6. PRACTICAL APPLICATIONS, ADVANTAGES, AND IMPROVEMENTS
7. COMPUTER NETWORKS AND CLOUD NETWORKS
8. HARDWARE OVERVIEW
9. MISCELLANEOUS; EXTENSIONS

### 1. General Overview

One or more embodiments implement a chatbot that reorganizes links to promote the selection of non-selected links. The chatbot displays a set of links in response to a query or request. The set of links may include, for example, a first link and a second link that is displayed below the first link. When the system receives a user selection of a first link from the displayed set of links, the system displays a resource corresponding to the first link. When the system receives user input triggering the re-display of the set of links, the system reorganizes the set of links such that the selected first link is presented below the non-selected second link. Similarly, the system may continue reorganizing the set of links each time a link is selected and/or user input requesting a re-display of the set of links is received. The reorganization of the links promotes non-selected links above previously selected links.

One or more embodiments implement a chatbot that enables selection of a valid combination of actions while disabling the selection of an invalid combination of actions. Initially, the system receives a message in a human-readable format in a chat interface. Using a Natural Language Processing (NLP) model, the system determines a set of candidate actions based on the message. The system displays interface elements associated respectively with the candidate actions. When the system receive user input selecting a first interface element corresponding to a first candidate action, the system disables the selectability of a second interface element corresponding to a second candidate action that conflicts with the first candidate action. The second interface element is displayed in a non-selectable mode. Furthermore, the system maintains the selectability of a third interface element corresponding to a third candidate action that does not conflict the first candidate action.

One or more embodiments described in this Specification and/or recited in the claims may not be included in this General Overview section.

### 2. Interactive Chat Interface Architecture

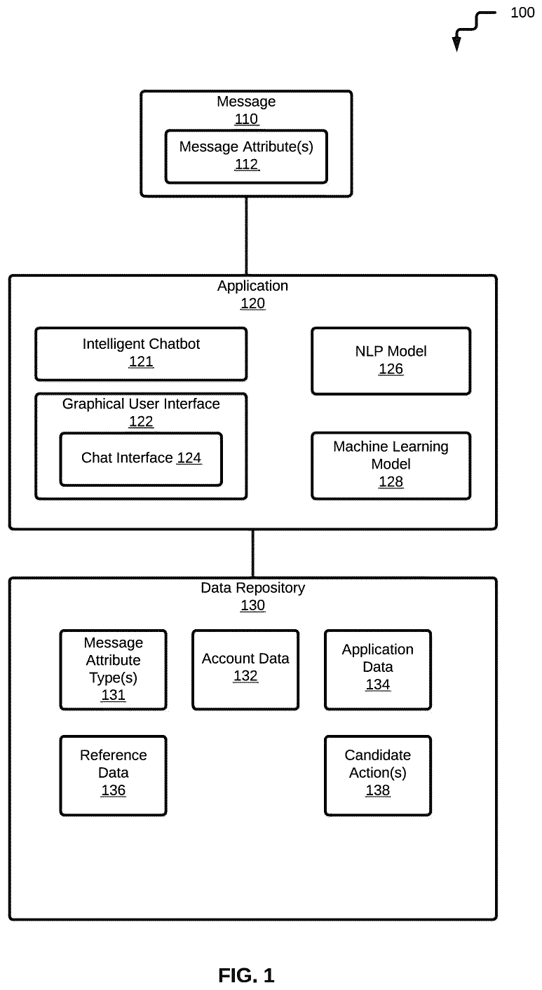

FIG. 1 illustrates a system 100 in accordance with one or more embodiments. As illustrated in FIG. 1, system 100 includes an application 120 and a data repository 130. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

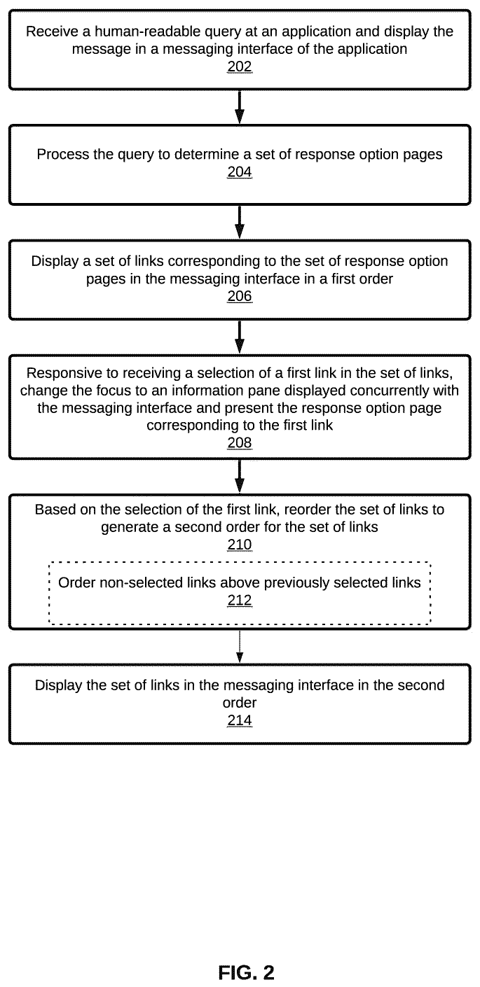

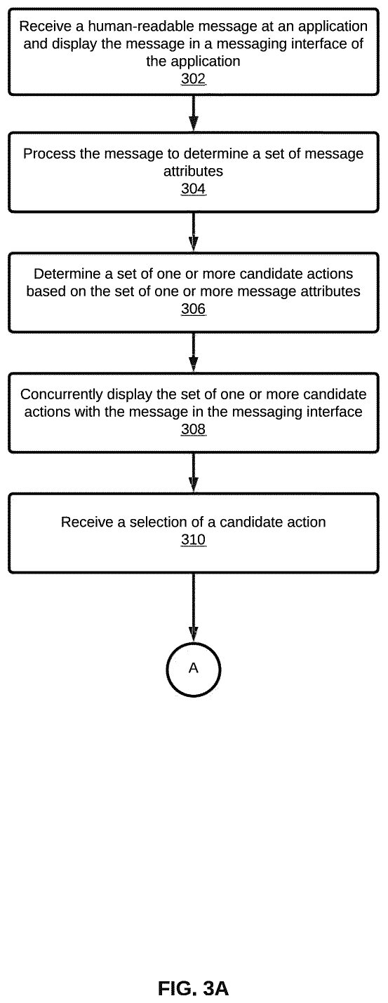

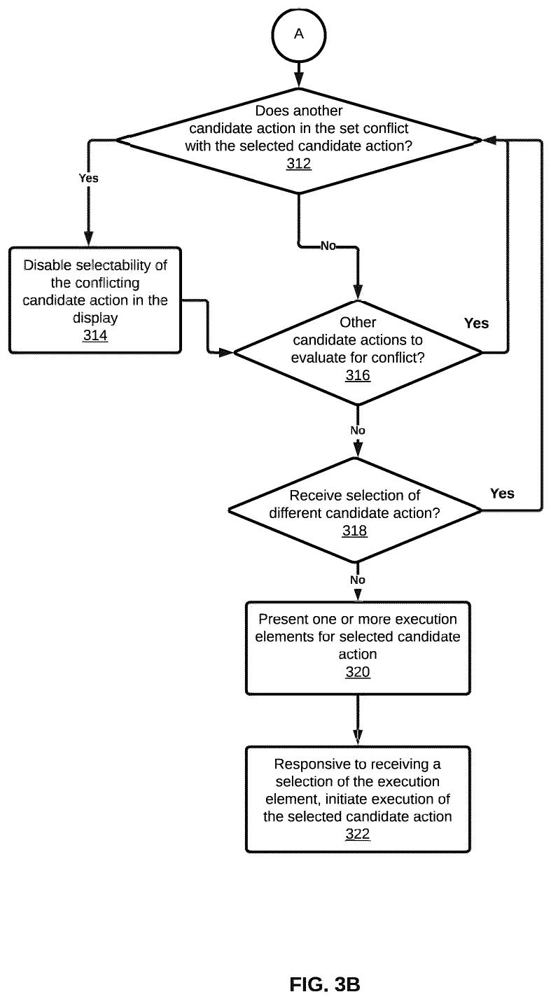

In one or more embodiments, the application 120 refers to hardware and/or software configured to perform operations described herein for presenting and dynamically updating an interactive chat interface. The application 120 may be a business management application, such as a medical practice application, with an interactive chat interface that allows users to interact with other users and with clients, store and retrieve information and data records, and initiate actions. The application 120 may include one or more functional components, such as an intelligent chatbot 121, a graphical user interface (GUI) 122, a natural language processing (NLP) model 126, and a machine learning model 128. Examples of operations for presenting and dynamically updating an interactive chat interface are described below with reference to FIGS. 2 and 3.

The application 120 may be configured to receive a message 110 from a user of the application or from an external user. The message 110 may be in a human-readable format, for example, text entered from a keyboard or from a speech-to-text conversion operation. The message 110 may have one or more message attributes 112 of one or more message attribute types 131. Message attribute types 131 may include, for example, a keyword, a timestamp, a sender identity, and/or a recipient identity. A keyword may include a word or word phrase that is mapped to information and/or an action that the application can execute. A timestamp may identify a date and time when the message was sent, received, read, and/or stored. A sender identity may include a name, an address, and/or a unique identifier for an individual or entity that sent the message. A recipient identity may include a name, an address, and/or a unique identifier for an individual or entity to whom the message is directed.

The application 120 may generate and display a variety of GUI components with GUI 122 to allow users to interact with the functions and information of the application. The GUI 122 refers to hardware and/or software configured to facilitate communications between a user and the application 120. GUI 122 renders user interface elements and receives input via user interface elements. Examples of user interface elements include checkboxes, radio buttons, dropdown lists, list boxes, buttons, toggles, text fields, date and time selectors, command lines, sliders, pages, and forms.

In an embodiment, different components of GUI 122 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, GUI 122 is specified in one or more other languages, such as Java, C, or C++. GUI 122 displays the message 120 in a chat interface 124. The chat interface 124 may include, for example, a message display component and a message composition field.

The intelligent chatbot 121 may be configured to identify the message attributes of the message, for example, by using the NLP model 126 to identify keywords, other words, and word phrases in the message. The intelligent chatbot 121 may also determine timestamp information as well as sender and/or intended recipient information.

The intelligent chatbot 121 may be configured to access application information based on the message attributes to identify information that may be responsive to a query in a message. The intelligent chatbot 121 may be configured to access application information based on the message attributes to identify one or more candidate actions for the application to execute responsive to the message.

Application information can include account data 132. Account data 132 may include information identifying and describing clients served by the application. The information can include contact information, account numbers, data records about the user or client, and so forth. For a medical practice application, the account data can include patient records that include current and past medical conditions, medications, test results, and so forth. For a commercial business practice application, the account data can include client accounts, billing and invoice records, work product produced for a client, contracts, and so forth.

Application information can include application data 134. Application data 134 can include information used by the application 120 as part of the functions the application performs. For example, the application data 134 can include calendar and scheduling information, personnel accounts, and application-specific reference information. For a medical practice application, the application data 134 can include information about medications, conditions addressed by the medications, available dosages for the medications, contraindications for the medications, and so forth. The application data 134 could include, for the users of the applications, employee records, specialties, certifications, hospital privileges and so forth.

The intelligent chatbot 121 can access reference data 136 to respond to a query in a message. Reference data 136 can include information that can be provided in answer to a query, such as, but not limited to: journal articles, online encyclopedias, user manuals, internal knowledge base articles, or any materials accessible through a private or public search engine. Reference data 136 may be presented in response to a query in a message with selectable links presented in the chat interface. The intelligent chatbot may also store information identifying the users that have viewed the information referenced by a link. The intelligent chatbot 121 can present links to reference data in the chat interface 124.

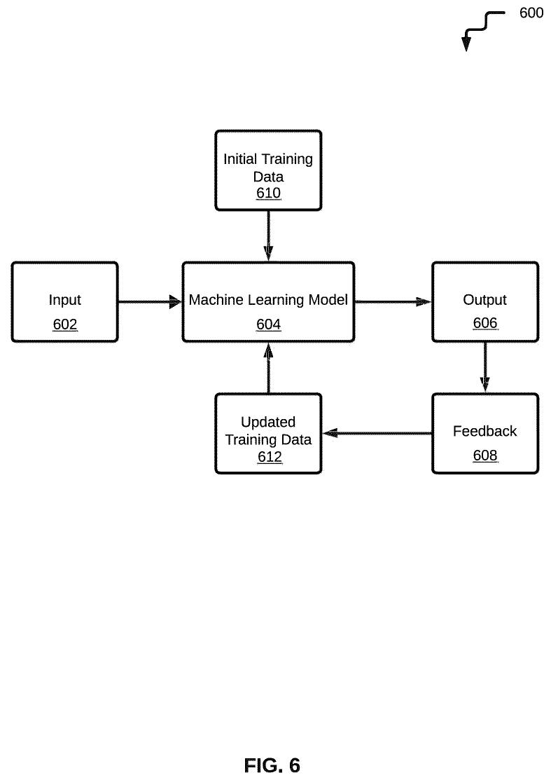

The intelligent chatbot 121 can generate candidate actions 138 based on the message attributes of a message. A candidate action 138 can be a function or operation that the application 120 can execute. When generated, the candidate action is in an unexecuted state. For example, a candidate action can be for generating or editing a calendar entry, ordering a supply item, ordering a prescription, ordering a test, generating a referral order, generating and/or sending an invoice, or sending a reminder message. The intelligent chatbot 121 can use the machine learning model 128 to determine a set of candidate actions based on the message attributes. The intelligent chatbot 121 presents an interface element corresponding to a candidate action in the chat interface 124. The intelligent chatbot 121 determines if a presented candidate action conflicts with a selected candidate action. When one candidate action conflicts with another candidate action, the intelligent chatbot 121 disables the ability to select the conflicting candidate action. An example of a machine learning model and process is described below with reference to FIG. 6.

In one or more embodiments, a data repository 130 is any type of storage unit and/or device (e.g., a file system, database, collection of tables, or any other storage mechanism) for storing data. Furthermore, a data repository 130 may include multiple different storage units and/or devices. The multiple different storage units and/or devices may or may not be of the same type or located at the same physical site. Furthermore, a data repository 130 may be implemented or executed on the same computing system as application 120. Additionally, or alternatively, a data repository 130 may be implemented or executed on a computing system separate from application 120. The data repository 130 may be communicatively coupled to application 120 via a direct connection or via a network.

Additional embodiments and/or examples relating to computer networks are described below in Section 7 titled “Computer Networks and Cloud Networks.”

Information describing message attribute types 131, account data 132, application data 134, reference data 136, and candidate actions 138 may be implemented across any of components within the system 100. However, this information is illustrated within the data repository 130 for purposes of clarity and explanation.

### 3. Dynamically Updating a Chat Interface

FIG. 2 illustrates an example set of operations for presenting links dynamically in a chat interface in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system receives a human-readable query at an application and displays the query in a chat interface of the application (Operation 202). The system may present the chat interface, including a message composition field, as a part of a GUI of the application. The user may enter text into the message composition field, for example, from a keyboard, a speech-to-text conversion operation, or a drag-and-drop operation using text selected from elsewhere. The query may be received as a text message, e.g., an SMS message.

In an embodiment, the system processes the query to determine a set of response option pages (Operation 204). The system may parse the query to identify keywords, for example, with an NLP model. The system may also identify one or more message attributes such as the sender of the query. The system constructs one or more search queries from the parsed query. The system may expand on the words used in the received query, for example, by constructing search queries that use synonyms or related terms. For example, if the received query is the string “What are the recommended treatments for a patient with diabetes and hypertension?”, the system may construct search queries that include the words “medications, drugs, pharmaceuticals” in addition to “treatment”. The system searches reference data for pages that include information responsive to the one or more search queries.

In an embodiment, the system chooses a predetermined number of response option pages to include in the set of response option pages if the number of response option pages returned exceeds the predetermined number. In an embodiment, the system calculates a relevancy score for the pages returned by the search and selects the response option pages having the highest relevancy scores to include in the set of response option pages. The relevancy score may be based, for example, on how many of the search query terms are present in the page, how frequently a search term appears on a page, a percentage of how often the page is viewed when presented in response to a similar search query, or a combination of these factors.

In an embodiment, the system displays a set of links corresponding to the set of response option pages in the chat interface in a first order (Operation 206). The system may determine the first order based on a ranking of the relevancy score of the individual response option pages. The system may alternatively determine the first order alphabetically by title of the page, by the order received from the search operation, or by the number of views the individual pages have received. The system displays the links within the chat interface, for example, below the query text or as a drop-down menu from the query field within the chat interface. The links may be displayed as, for example, a list of hypertext links with one link per line, a side-by-side display of links, or a grid display of links.

In an embodiment, responsive to receiving a selection of a first link in the set of links, the system changes the focus in the application to an information pane displayed concurrently with the chat interface and presents the response option page corresponding to the first link in the information page (Operation 208). The system retrieves the page corresponding to the first link and displays or renders the page in an information pane of the application GUI. If the information pane is already open, the system replaces the previous contents of the information pane with the information from the retrieved page. If the information pane is not already open, the system opens the pane and presents the information from the page in the information pane. The chat interface may remain present and visible in the GUI and may continue to display the received query. The display of links may be collapsed to show fewer links in a smaller portion of the GUI, so the information pane is not obscured.

In an embodiment, the system, based on the selection of the first link, reorders the set of links to generate a second order for the set of links (Operation 210). As one option, the system can order non-selected links above or in front of the first link and any other previously selected links (Operation 212). The system may move the first link to the end or bottom of the set of links. If there are other previously viewed links, the system may position the first link at the end or bottom of the set of links. Alternatively, the system may divide the set of links into a set of unviewed links and a set of viewed links and may move the first link from the set of unviewed links to the set of viewed links. The system may order the set of viewed links according to the same criteria used to establish the first order. The system may position the set of viewed links at the end or bottom of the set of unviewed links.

In an embodiment, the system displays the set of links in the chat interface in the second order (Operation 214). The system may display the set of links in the second order, for example, in response to a user selection of the chat interface. The system may display the set of links in the second order when the user closes or navigates away from the page presented in the information pane, or after any other change of focus within the GUI. The system may visually modify the first link to indicate a previous selection. For example, the system may change the font, font color, font emphasis (e.g., bold, italic, underline), font size, or any other visual aspect of the displayed link.

FIGS. 3A-B illustrate an example set of operations for presenting candidate actions dynamically in a chat interface in accordance with one or more embodiments. One or more operations illustrated in FIGS. 3A-B may be modified, rearranged, or omitted. Accordingly, the particular sequence of operations illustrated in FIGS. 3A-B should not be construed as limiting the scope of one or more embodiments.

In an embodiment, the system receives a human-readable message at an application and displays the message in a chat interface of the application (Operation 302). The system may present the chat interface, including a message composition field, as a part of a GUI of the application. The user may enter text into the message composition field, for example, from a keyboard, a speech-to-text conversion operation, or a drag-and-drop operation using text selected from elsewhere. The query message be received as a text message, e.g., an SMS message.

In an embodiment, the system processes the message to determine a set of message attributes (Operation 304). The system may parse the query to identify keywords, for example, with an NLP model. The system may also identify one or more message attributes, such as the sender of the query, a named recipient, a timestamp, or other data about the message.

In an embodiment, the system determines a set of one or more candidate actions based on the one or more message attributes (Operation 306). The message may be an instruction or command to the application to initiate or perform an action. The message may be ambiguous or may be missing information that the application needs to initiate or perform the action autonomously. Accordingly, the system may use the message attributes and other context information to determine a set of candidate actions that may fulfill the action in the message. The system may consider the message sender, one or more keywords in the message, and other information in view in the GUI when determining a set of candidate actions.

The system may use a machine learning model to determine the set of candidate actions. The machine learning model may take the message attributes as inputs and may output the set of candidate actions.

By way of example, in a medical practice management application, the message may say “Order penicillin”. The system can determine that the context of the message is that the application is currently showing information for a particular patient to a particular physician. The system can identify different dosages available for penicillin, different brand name and generic versions of penicillin, what the particular patient's insurance will cover, if the patient has any allergies to the medication, and/or if the patient is taking other medications that are contraindicated with penicillin. The system can create different candidate actions corresponding to different variations of the options that can fulfill the instruction. For example, the system can create a first candidate action to order one medication at a first dose, a second candidate action to order the medication at a second dose, and a third candidate action to order a different medication at a third dose.

In an embodiment, the system concurrently displays the set of candidate actions with the message in the chat interface (Operation 308). The system creates a separate interface element for the respective candidate actions in the set of candidate actions. The system presents the interface elements in the chat interface, for example, below the received message.

In an embodiment, the system receives a selection of a candidate action (Operation 310). The system may identify a selection operation from the user, for example, a mouse button click when an associated cursor is positioned over an interface element. The system may modify the display of the selected interface element to indicate the selected state, for example, by changing a color, line weight, shading, or other visual aspect of the selected interface element.

Continuing to FIG. 3B, in an embodiment, the system determines if there is a candidate action in the set of candidate actions that conflicts with the selected candidate action (Operation 312). A conflict may occur when no more than one candidate action can be executed in response to the message. For example, when no more than one prescription for a medication should be ordered, other candidate actions for ordering that medication at different dosages conflict with a selected candidate action for ordering that medication. A conflict may occur when two or more candidate actions may be selected concurrently, but one candidate action is contraindicated or mutually exclusive with the select action. For example, when two medications should not be used together, the selection of one of the medications would cause a candidate action for the second medication to conflict. The system may access metadata associated with a candidate action and reference data to determine that a conflict exists. The metadata for a candidate action may indicate, for example, other actions that cannot be performed with the selected candidate action. The system may refer to application rules to identify conflicting actions. For example, the application may have a rule that prevents the creation of two meetings for one individual that occur at the same time with different people or at two different locations. The application may have a rule that prevents two different orders for the same product in two different quantities at the same time for the same person.

In an embodiment, when there is a candidate action that conflicts with the selected candidate action, the system disables the selectability of the conflicting action (Operation 314). The system continues to display the interface element corresponding to the disabled candidate action but does not allow the disabled interface element to be selected by the user. The system may modify the visual appearance of the disabled interface element to indicate that the element is disabled, for example, by changing a line style, line weight, font, color, shading, color, or other visual aspect of the disabled interface element. In an embodiment, the system hides the interface element for the conflicting action from the display while keeping the corresponding candidate action in the set of candidate actions.

In an embodiment, the system can determine a probability that a second of the candidate actions will be selected concurrently with a currently selected candidate action based on historical data that tracks the creation of candidate actions and selection activity associated with the candidate actions. When the probability of selection is low, the system can disable the selectability of the corresponding interface element for the second candidate action.

In an embodiment, the system determines if there are other candidate actions in the set of candidate actions to evaluate for conflict with the selected candidate action (Operation 316). If there are other candidate actions in the set of candidate actions that have not yet been evaluated for conflict, the system returns to Operation 312 to evaluate the other candidate actions. Otherwise, the system determines if a different candidate action is now selected (Operation 318). The system may determine if the user has selected either an additional candidate action or a candidate action different from the previously selected candidate action. If a different or additional candidate action is now selected, the system returns to Operation 312. When a different candidate action is selected and the previously selected candidate action is deselected, the system may re-enable the interface elements of any previously disabled candidate actions prior to returning to Operation 312.

In an embodiment, once the candidate actions have been evaluated for conflict with the selected candidate action, the system presents one or more execution elements for a selected candidate action (Operation 320). The system may present a separate interface element, such as a button, that causes the system to execute the selected candidate action. Additionally, or alternatively, the system may accept a selection operation from an input device, such as a double-click action on the interface element for the candidate action, or the system may accept a selection of the “enter” or “return” key on a keyboard while the interface element for the candidate action is selected.

In an embodiment, the system initiates execution of the selected candidate action when the execution element for the candidate action is selected (Operation 322). The system may instruct the application to perform the selected candidate action, for example, by issuing a command or function call corresponding to the candidate action.

### 4. Example Embodiments

Several detailed examples are described below for purposes of clarity. Components and/or operations described below should be understood as one specific example that may not be applicable to certain embodiments. Accordingly, components and/or operations described below should not be construed as limiting the scope of any of the claims.

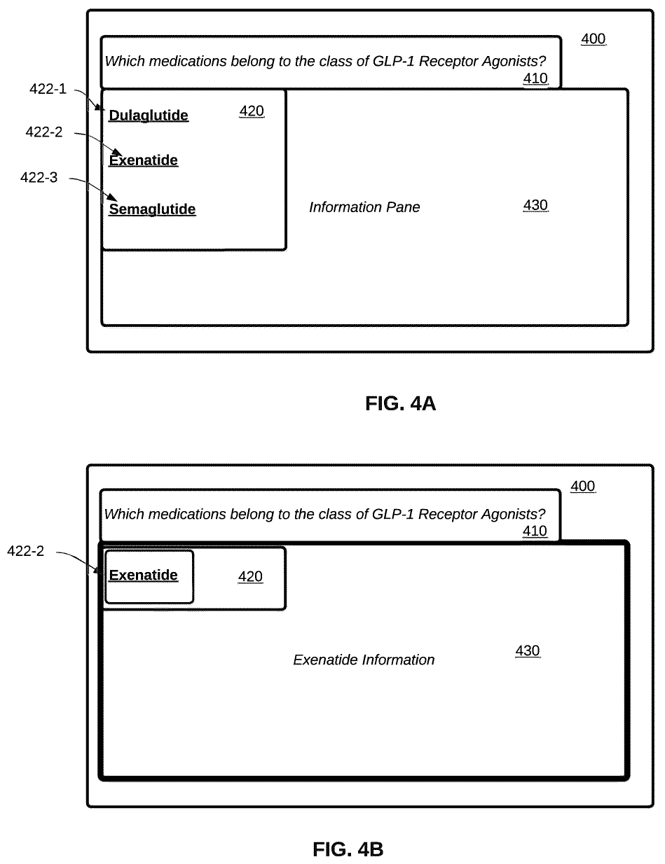

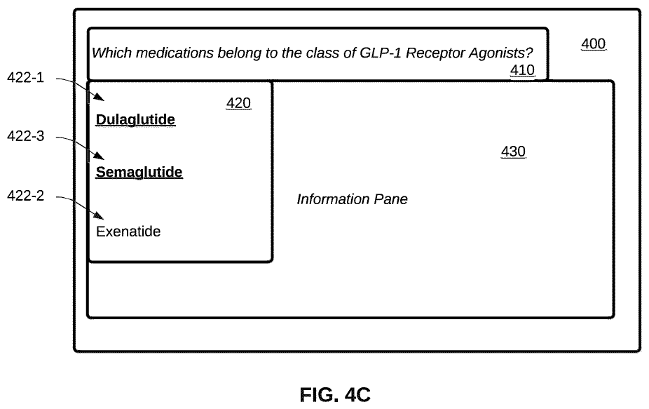

FIGS. 4A-C illustrate an example of an interactive chat interface in accordance with one or more embodiments. FIG. 4A shows a graphical user interface (GUI) 400 for an application. The GUI 400 includes a message composition field 410, where a user has entered the query “Which medications belong to the class of GLP-1 Receptor Agonists?” The GUI 400 displays a set of links 422-1, 422-2, and 422-3 in a link section 420. The link section 420 may be a drop-down pane from the message composition field 410 or may be a part of the message composition field 410. The GUI 400 includes an information pane 430 that is operative to present information, for example, from documents, web pages, databases, multimedia sources, and so forth.

FIG. 4B shows the GUI 400 after a user has selected link 422-2. The application retrieves and loads the information referenced by link 422-2 into the information pane 430. The GUI may partially or completely collapse the link section 420 to expose more or all of the information pane 430.

FIG. 4C shows the GUI 400 after the user has changed focus, for example, by placing a cursor in the message composition field 410 or over the link section 420 and clicking or otherwise selecting the part of the GUI located at the cursor. The link section 420 is expanded and shows the links in a second order. The previously followed link 422-2 is now below the unfollowed links 422-1 and 422-3. The link 422-2 is also visually modified to indicate that the link was previously followed, for example, by removing bold and underlined effects.

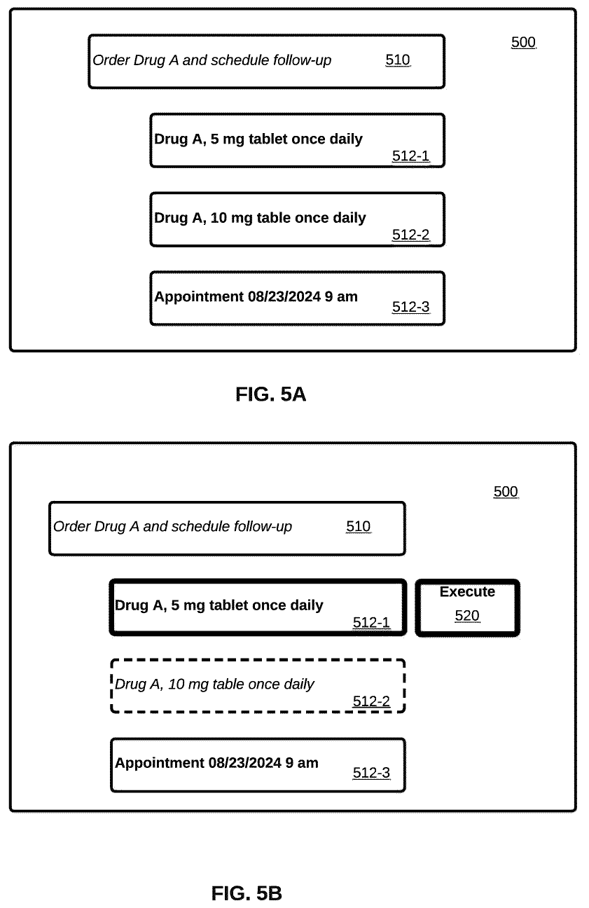

FIGS. 5A-B illustrate another example of an interactive chat interface in accordance with one or more embodiments. FIG. 5A shows a GUI 500 for an application. The GUI 500 has a message composition field 510, where, in this example, a user has entered a message for an intelligent chatbot to order Drug A and schedule a follow-up appointment. The intelligent chatbot has processed the human readable message and determined three candidate actions based on message attributes: (1) a prescription order for Drug A at a first dose, (2) a prescription order for Drug A at a second dose, and (3) a calendar event. The intelligent chatbot causes the GUI 500 to present interface elements 512-1, 512-2, and 512-3. Interface elements 512-1, 512-2, and 512-3 correspond to the three candidate actions, respectively. As seen in FIG. 5A, each of the interface elements 512-1, 512-2, and 512-3 are selectable.

FIG. 5B shows the GUI 500 after a user has selected interface element 512-1 corresponding to the candidate action to order Drug A as a 5 mg tablet. Responsive to the selection, the intelligent chatbot has determined that the candidate action for ordering Drug A as a 10 mg tablet conflicts with the selected candidate action and has disabled the selectability of interface element 512-2. Interface element 512-3 remains selectable because the candidate action to create a calendar event does not conflict with the selected candidate action. The GUI 500 may visually modify interface element 512-1 to indicate that the element is selected, e.g., with a heavier line weight, a different color, a different shading, and so forth. The GUI 500 may also visually modify interface element 512-2 to indicate that the element is disabled. The GUI 500 may also present an execution element 520 for the user to select to instruct the application to perform the selected candidate action.

### 5. Machine Learning

FIG. 6 illustrates a machine learning process 600 according to one or more embodiments. A machine learning model 604 may be iteratively trained on initial training data 610 to map a set of input variables to an output variable. The initial training data 610 may include message attributes and candidate actions mapped to one or more message attributes.

Once trained initially, the machine learning model 604 may act on an input 602, such as message attributes determined from a message from an NLP model. The output 606 may be one or more candidate actions.

The training data may be updated based on, for example, feedback 608 on the accuracy of the current machine learning model 604. Updated training data 612 is fed back into the machine learning algorithm that, in turn, updates the machine learning model 604.

A machine learning model 604 is trained such that the model best fits the datasets of training data to the labels or outputs of the training data. Additionally, or alternatively, machine learning model 604 is trained such that when the model is applied to the datasets of the training data, a maximum number of results determined by the model matches the labels or outputs of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 6. Practical Applications, Advantages, and Improvements

Links to responses to queries in an application are conventionally displayed in a window such as a web browser window. When a link is selected, the user usually has to navigate away from the displayed links, for example, to a separate page or tab, or the display of the links is replaced in the same window with the contents of the linked response. After a link is selected, if the user wishes to follow a different link, the user is required to navigate back to the links display, where the links are still displayed in the same order. This may require the user to scroll to find an unexplored link.

One or more embodiments present links to responses within a chat interface that is available even while information from a followed link is presented in an application GUI. The system also re-orders the link display, so unfollowed links appear at the top or beginning of the display, improving efficiency and user experience in following additional links.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

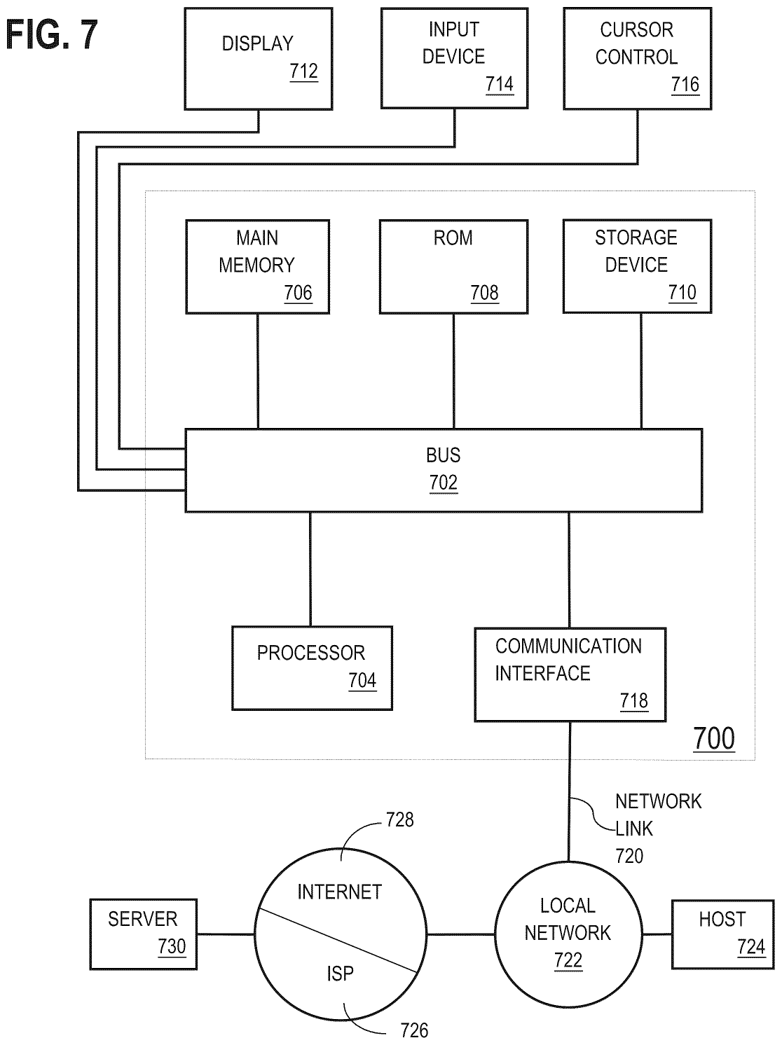

For example, FIG. 7 is a block diagram that illustrates a computer system 700 that can be used to implement an embodiment of the disclosure. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or a Solid-State Drive (SSD) is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic that, in combination with the computer system, causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into the remote computer's dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706. Processor 704 retrieves and executes the instructions from main memory 706. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. Example forms of transmission media include the signals through the various networks, the signals on network link 720, and the signals that carry the digital data to and from computer system 700 through communication interface 718.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as the code is received, and/or stored in storage device 710, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form that such claims issue, including any subsequent correction.

1. (canceled)

2. (canceled)

3. (canceled)

4. One or more non-transitory computer readable media storing program instructions that, when executed by one or more hardware processors, cause performance of operations comprising:
presenting a chat interface as a component of a graphical user interface presented by an application;
receiving a message in a human-readable format in the chat interface;
applying a Natural Language Processing (NLP) model to the message to determine a particular set of message attributes corresponding to the message;
creating a set of candidate actions based on with the one or more message attributes of the particular message attributes;
displaying, in the graphical user interface, a set of interface elements associated respectively with the candidate actions in the set of candidate actions;
responsive to receiving a selection of a first interface element corresponding to a first candidate action in the set of candidate actions:
determining that a second candidate action in the set of candidate actions conflicts with the first candidate action;
disabling selectability of a second interface element corresponding to the second candidate action in the display of the interface elements, wherein disabling the selectability of the second interface element comprises displaying the second interface element in a non-selectable mode;
determining that a third candidate action in the set of candidate actions does not conflict with the first candidate action; and
maintaining selectability of a third interface element corresponding to the third candidate action in the display of the interface elements;
subsequent to disabling selectability of the second user interface element: receiving user input selecting an execution element displayed in the graphical user interface; and
responsive to receiving the user input selecting the execution element, executing at least the first candidate action.

5. The non-transitory media of claim 4, the operations further comprising:
responsive to receiving the selection of the first interface element, determining that a fourth candidate action in the set of candidate actions conflicts with the first candidate action; and
hiding a fourth interface element corresponding to the fourth candidate action from the display.

6. The non-transitory media of claim 4, the operations further comprising, subsequent to disabling the selectability of the second interface element, displaying the second interface element in a non-selectable mode.

7. The non-transitory media of claim 4, the operations further comprising:
responsive to receiving the selection of the first interface element:
determining a probability that a fourth candidate action in the set of candidate actions will be selected concurrently with the first candidate action based on historical data; and
disabling the selectability of a fourth interface element corresponding to the fourth candidate action from the display when the probability is below a threshold.

8. The non-transitory media of claim 4, the operations further comprising:
receiving a second selection of a fourth interface element corresponding to a fourth candidate action, wherein the first interface element is deselected by the second selection;
determining that the second candidate action in the set of candidate actions does not conflict with the fourth candidate action; and
enabling selectability of the second interface element corresponding to the second candidate action in the display of the interface elements.

9. The non-transitory media of claim 4, the operations further comprising:
presenting an execution element corresponding to the selected first interface element; and
responsive to receiving the user selection of the execution element,
removing the set of candidate actions from the chat interface.

10. The non-transitory media of claim 4, the operations further comprising:
receiving a second selection of the third interface element wherein the first interface element remains selected;
presenting one or more execution elements corresponding to the first candidate action and the third candidate action; and
responsive to receiving a third selection of the one or more execution elements, initiating execution of the first candidate action and the third candidate action.

11. The one or more non-transitory computer readable media of claim 4, the operations further comprising:
training a machine learning model to determine candidate actions based on message attributes based on training data sets, wherein the training data sets include a first training data set comprising:
a first message attribute; and
a first candidate action mapped to the first message attribute;
wherein determining the one or more candidate actions based on the particular set of message attributes comprises applying the machine learning model to the particular set of message attributes to determine the one or more candidate actions.

12. The non-transitory media of claim 4, wherein the first candidate action comprises a refill action for a first medication, and the second candidate action comprises a refill action for a second medication, wherein the second medication is contraindicated for use with the first medication.

13. The non-transitory media of claim 4, wherein the first candidate action comprises a refill action for a first medication at a first dosage, and the second candidate action comprises a refill action for the first medication at a second dosage.

14. The non-transitory media of claim 4, wherein the first candidate action comprises a refill action for a first medication, and the third candidate action comprises a scheduling action.

15. (canceled)

16. (canceled)

17. (canceled)

18. A system comprising:
one or more hardware processors;
one or more non-transitory computer-readable media; and
program instructions stored on the one or more non-transitory computer-readable media that, when executed by the one or more hardware processors, cause the system to perform operations comprising:
presenting a chat interface as a component of a graphical user interface presented by an application;
receiving a message in a human-readable format in the chat interface;
applying a Natural Language Processing (NLP) model to the message to determine a particular set of message attributes corresponding to the message;
creating a set of candidate actions based on one or more message attributes of the particular message attributes;
displaying, in the graphical user interface, a set of interface elements associated respectively with the candidate actions in the set of candidate actions;
responsive to receiving a selection of a first interface element corresponding to a first candidate action in the set of candidate actions:
determining that a second candidate action in the set of candidate actions conflicts with the first candidate action;
disabling selectability of a second interface element corresponding to the second candidate action in the display of the interface elements;
determining that a third action in the set of actions does not conflict with the first action; and
maintaining selectability of a third interface element corresponding to the third action in the display of the interface elements; and
subsequent to disabling selectability of the second user interface element: receiving user input selecting an execution element displayed in the graphical user interface;
responsive to receiving the user input selecting the execution element, executing at least the first candidate action.

19. The system of claim 18, the operations further comprising:
receiving a second selection of a fourth interface element corresponding to a fourth candidate action, wherein the first interface element is deselected;
determining that the second candidate action in the set of candidate actions does not conflict with the fourth candidate action; and
enabling selectability of the second interface element corresponding to the second candidate action in the display of the interface elements.

20. The system of claim 18, the operations further comprising:
training a machine learning model to determine candidate actions based on message attributes based on training data sets, wherein the training data sets include a first training data set comprising:
a first message attribute; and
a first candidate action mapped to the first message attribute;
wherein determining the one or more candidate actions based on the particular set of message attributes comprises applying the machine learning model to the particular set of message attributes to determine the one or more candidate actions.

21. A method comprising:
presenting a chat interface as a component of a graphical user interface presented by an application;
receiving a message in a human-readable format in the chat interface;
applying a Natural Language Processing (NLP) model to the message to determine a particular set of message attributes corresponding to the message;
creating a set of candidate actions based on one or more message attributes of the particular message attributes;
displaying, in the graphical user interface, a set of interface elements associated respectively with the candidate actions in the set of candidate actions; and
responsive to receiving a selection of a first interface element corresponding to a first candidate action in the set of candidate actions:
determining that a second candidate action in the set of candidate actions conflicts with the first candidate action;
disabling selectability of a second interface element corresponding to the second candidate action in the display of the interface elements;
determining that a third action in the set of actions does not conflict with the first action; and
maintaining selectability of a third interface element corresponding to the third action in the display of the interface elements; and
subsequent to disabling selectability of the second user interface element: receiving user input selecting an execution element displayed in the graphical user interface; and
responsive to receiving the user input selecting the execution element, executing at least the first candidate action;
wherein the method is performed by at least one device including a hardware processor.

22. The method of claim 21, wherein creating the set of candidate actions based on one or more message attributes of the particular message attributes comprises generating the first candidate action configured to perform a first function or operation using a first set of parameters and the second candidate action configured to perform the first function or operation using a second set of parameters.

23. The method of claim 21, further comprising:
responsive to receiving the selection of the first interface element:
determining a probability that a fourth candidate action in the set of candidate actions will be selected concurrently with the first candidate action based on historical data; and
disabling the selectability of a fourth interface element corresponding to the fourth candidate action from the display when the probability is below a threshold.

24. The method of claim 21, further comprising:
receiving a second selection of a fourth interface element corresponding to a fourth candidate action, wherein the first interface element is deselected by the second selection;
determining that the second candidate action in the set of candidate actions does not conflict with the fourth candidate action; and
enabling selectability of the second interface element corresponding to the second candidate action in the display of the interface elements.

25. The method of claim 21, further comprising:
after determining that the second candidate action conflicts and that the third candidate action does not conflict, presenting, in the graphical user interface, the execution element corresponding to the first candidate action and configured to execute the first candidate action when selected.

26. The method of claim 21, further comprising:
training a machine learning model to determine candidate actions based on message attributes based on training data sets, wherein the training data sets include a first training data set comprising:
a first message attribute; and
a first candidate action mapped to the first message attribute;
wherein determining the one or more candidate actions based on the particular set of message attributes comprises applying the machine learning model to the particular set of message attributes to determine the one or more candidate actions.
